(19) United States
(12) Patent Application Publication
(10) Pub. No.: US 2019/0224507 A1
(43) Pub. Date: Jul. 25, 2019

(54) APPARATUS AND SYSTEM FOR PREVENTING AND EXTINGUISHING FIRES, INSTALLABLE ON HEAVY GOODS INDUSTRIAL VEHICLES

(71) Applicant: Giuseppe Fiorino, Cassano delle Murge (IT)

(72) Inventor: Giuseppe Fiorino, Cassano delle Murge (IT)

(21) Appl. No.: 16/317,254

(22) PCT Filed: Jul. 13, 2017
(86) PCT No.: PCT/IB2017/000831

§ 371 Date: Jan. 11, 2019

(30) Foreign Application Priority Data
Jul. 14, 2016 (EP) 16425069.8

(51) Int. Cl. A62C 3/07; A62C 5/02; A62C 35/02; A62C 35/13; A62C 37/36

(52) U.S. Cl. CPC A62C 3/07; A62C 5/022; A62C 37/36; A62C 35/13; A62C 35/023

(57) ABSTRACT

Apparatus for extinguishing fires installable on heavy goods industrial vehicles, in particular trucks, comprising a device for the formation of extinguishing liquid, at least two hose reel for the delivering of said extinguishing liquid, each placed in a case provided with means for the activation of said device, characterized in that the device for the formation of the extinguishing liquid is a compact, modular, standardizable device equipped with:
at least one substantially toroidal-shaped tank containing a solution of water and foaming agent and delimiting a compartment,
at least one pressurization box containing pressurization means,
at least one mixing chamber in which a solution composed by water and foaming agent coming from the tank and nitrogen/air coming from the pressurization box is formed,
   said compartment being bounded by the tank which hosts at least one pressurization box containing said pressurization means and at least one mixing chamber and said components being operatively interconnected by connecting means between the pressurization box and the mixing chamber, connecting means between the mixing chamber and the tank and connecting means between the mixing chamber and at least two hose reel.

### REFERENCE TO RELATED APPLICATIONS

This application is a U.S. national stage application of International Patent Application No. PCT/IB2017/000831, filed Jul. 13, 2017, and claims the benefit of priority of European Application No. 16425069.8, filed Jul. 14, 2016, the entire disclosures of which are incorporated herein by reference.

### FIELD OF THE INVENTION

The present invention relates generally to extinguishing fire systems and more in detail it refers to an apparatus provided with operatively interconnected devices for the formation and the delivering of an extinguishing liquid.

More in detail the present invention relates to an apparatus provided with a compact, modular and customizable device for the formation and pressurization of the extinguishing liquid suitable to the rapid extinguishing of fires and to the installation on heavy goods industrial vehicles commercially available and which allows a safe and efficient use by a single operator.

The present invention relates furthermore to a system for warn and prevent fires on said industrial vehicles through the activation of said device manually on ground close to the vehicle.

### BACKGROUND

The mechanical components of a heavy goods vehicle that runs daily the streets are subjected to remarkable stress; this stress is manifested by a high thermal gradient that is immediately transmitted from the brakes to the tires.

Once the temperature of self-ignition of the tire has been reached, there is a potential source of fire, which, if not promptly reported, can cause a remarkable concatenation of events, sometimes catastrophic.

The reason is often to be found also in the breaking of the supply alimentation circuit of the fuel, in drawbacks due to a faulty wiring of the engine or of the electric circuits, or in other mechanical failures.

In the case of transit of said vehicles in areas with heavy traffic or with risk of queues, especially in tunnels, said fires are a considerable risk because of:
limited access to the roadway and difficulty of abandonment of the same,
difficulty of evacuation of the smoke and the heat,
critical conditions to human survival: toxic fumes, high temperatures, critical or impaired visibility;
difficulties of access by the emergency relief,
difficulties in communications,
possible criticality of water supplies.

Currently, in order to deal with such a concatenation of events and intervene expeditiously, drivers have one or two portable fire extinguishers, depending on the type of load.

A portable fire extinguisher generally consist of the following components:
one or more tanks, suitable to contain the extinguishing agent, the propellant or both,
a valve, arranged to intercept and/or adjust the flow of the extinguishing agent,
a hose, namely a flexible tube that allows the easy addressing of the extinguishing agent in the appropriate directions (this may be lacking in small fire extinguishers, up to 3 kg),
an extinguishing agent that, sprayed or poured or otherwise placed in contact with the fire, interacts with it by turning it off, or by limiting it,
a propellant, gas suitable to the expulsion of the extinguishing agent.

The use of said extinguishers in the above cases, however, can be difficult and sometimes fatal for the driver of the truck; in fact he must come out quickly from the vehicle and spray on the rubber or on the wiring the extinguishing liquid with a small portable fire extinguisher, hoping that the extinguishing fire liquid is sufficient to extinguish the fire.

Said interventions are achievable only in case of a outbreak of fire, in fact once a fire flares up from the tire on the whole vehicle it is difficult or almost impossible to stop it with the portable extinguishers which are currently available on the heavy vehicles.

For example, the transport units carrying dangerous goods in accordance with the current legislation must be equipped with a portable fire extinguisher with a capacity that has a minimum from 2 to 12 kg of powder (or an equivalent capacity for any other suitable extinguishing agent).

Furthermore, with the current manual extinguishing systems, from the moment in which the driver sees smoke in his rear-view mirror to the time that he reaches the point of fire, after stopping his truck and after deciding to use a portable fire extinguisher, the time spent is too much to allow the effective use of that manual fire extinguisher because in the meantime the flame will spread dangerously over a controllable phase with manual equipment.

Despite the great progresses made in the construction of modern vehicles and particularly of their decor (now made exclusively with materials that delay the development of fire and with low emission of toxic fumes and vapors), in many situations the time necessary to allow the safe stop in a suitable place of the affected convoy by the fire can easily exceed the time in which the environmental conditions for the vehicle users and others nearby, as well as the goods transported, are tolerable on the basis of the only passive measures described above.

Among the systems for the extinguishing and the detection of fires on industrial vehicles there are known systems realized with temperature increase sensors, activation button, dispensing valves and tanks containing an extinguishing liquid, but they are often systems that were born with the vehicle and whose system on industrial vehicles is of complex realization by the fact that often the system comprises a structured maze of pipes, which often run through the entire length of the vehicle in order to bring the extinguishing liquid from the tank to the utility area which is often represented by the motor compartment, running along the entire length of the vehicle; the invention according to the present invention instead, by being compact it allows to be adapted to any industrial vehicle, and through the use of hoses reels it allows to extinguish the fire in any area of the vehicle, also having a tank that allows to have a plenty of fire extinguishing liquid and not simply a tank.

The patent US20120168184 shows a fire suppression system for a container including a first tank containing a first liquid component of a two-part foam and a second tank containing a second liquid component of the foam. The system also includes at least one liquid component release device configured to be selectively capable of releasing the first and second components from their respective containers upon receipt of a signal from a fire detector upon detection of a fire. The two-part foam components are propelled through the system by a pressurized propellant that, upon release of the release device, causes the exit of the foam components from their respective tanks, through a mixing conduit to at least one nozzle. The nozzle is configured to spray the liquid component foam mixture into the container wherein the foam cures into a substantially semi-rigid, closed cell foam that is substantially impermeable and may have charring and/or intumescence properties.

The patent US2004003929 reports a fire extinguishing system equipped on pick-up type trucks; it is evident that the overall dimensions of this system leads to occupy much of the tipping area of the pick-up thus limiting the use of the vehicle; the apparatus according to the invention is coupled by the use of brackets to the longitudinal members and therefore does not occupy parts of the industrial vehicle which could be used for other purposes.

The U.S. Pat. No. 2,867,281 shows some fire extinguishing systems on industrial vehicles designed to extinguish the fire in critical areas, such as the engine compartment or tires; however it is a system whose must be provided the insertion of the tanks in different positions on the vehicle; the apparatus according the invention is a retrofit, therefore, it is adaptable to any vehicle with ease of installation and at any time, and furthermore it presents a higher extinguishing warranty of any fire both for the size of the toroidal tank, and so the abundance of the extinguishing liquid for both the use of the hose reel that allows to reach the extinguishing liquid at any position on the industrial vehicle.

Among the systems for extinguishing fires on mobile vehicles and other vehicles, they are also known systems able to function in a completely autonomous and automatic way consisting of fire detection modules, from a central management module and processing the data and from shutdown modules.

Each module constitutes a component connected to a supply alimentation line and transmission of the data (limited to the shutdown modules) to a dorsal of the extinguishing liquid.

These systems allows a detection of fire and provide a targeted action of its shutdown, which can however be extended with the resources on board up to about 15 minutes.

In case of fire on the vehicle, such systems operate according to the following steps:

automatic mode:
suitable sensors detect the heat and send a signal to the control panel;
the control unit interprets the signal, start the download sequence by activating an alarm signal;
the linear actuator receives the signal from the control panel and opens the valve for the exit, through a fire-fighting network up to the nozzles, of the extinguishing liquid;
the fire is suppressed enabling the staff to evacuate the vehicle and to use the portable fire extinguisher or other methods, if necessary;

manual mode:
the operator can choose to press at any time the button of activation of the system in the cockpit or to the outside of it and start the download sequence.

Summarizing the problems of all the known systems, they are:
complexity of implementation/installation on heavy goods vehicles;
insufficient quantity of extinguishing liquid and insufficient ability to turn off already flared up fires;
long fire system and complex predisposition on the vehicle, as occupying different areas of the vehicle and in many cases able to extinguish fires only in some areas of the vehicle;
considerable encumbrance that affects more zones of the vehicle (ex. the engine compartment, passenger compartment);
difficulty of remote monitoring,
systems and remote devices are distant from each other and there is a difficult interaction,
difficulty to use them with a vehicle in motion,
difficult retrofit on existing heavy goods vehicles.

### SUMMARY OF THE INVENTION

The technical problem posed and solved by the present invention is therefore to provide a new and original solution that allows to overcome the above-mentioned drawbacks with reference to prior art.

In particular, the invention provides an original solution to the problem of providing an apparatus, provided with devices operatively interconnected for the formation and the delivery of an extinguishing liquid for extinguishing fires, suitable for the installation of heavy industrial vehicles commercially available and a system to report and prevent fires on those vehicles.

This problem is solved by an apparatus according to claim 1 comprising:
a device for pressurizing and for the formation of an extinguishing liquid, and
at least two hose reels for the dispensing of said extinguishing liquid placed each in a cassette provided with means for the activation of said device.

More in detail, said problem is solved by a device for the pressurization and formation of an extinguishing liquid that can be installed on heavy goods vehicles having the advantage of being compact, modular and customizable and whose activation occurs in remote from the cockpit by the operator or alternatively manually on ground close to the vehicle.

A further object of the present invention is to provide a fire-fighting device for heavy goods industrial vehicles, which allows a safe and efficient use by a single operator.

The object of the present invention is also to provide an apparatus whose activation can be carried out safely by the operator/driver manually on ground close to the vehicle or alternatively from the cockpit.

It is an apparatus that replaces the classic fire extinguishers and allows an active role against fire through the immediate action to avoid dangerous events.

A further advantage offered by the invention is to allow the retrofit of the device on existing heavy goods industrial vehicles available without the need to change the structure of the frame.

The apparatus according to the invention is simple and quick to install and, implemented in a monitoring and preventing fire system on heavy goods vehicles, it contributes to ensure an effective and rapid intervention of the operator/driver of the vehicle or in the case of remotely need.

Said monitoring system allows the driver to be constantly updated on the thermal situation of the vehicle components subject to any abnormal phenomena, such as on tires, using devices for the management and the detection of the temperature and the pressure connected to a remote monitor mounted in the cabin and provided with a specially designed software.

The system aims to prevent accidents occurring on the road due to spontaneous combustions of tires and other susceptible devices of the target vehicles.

In the case of tires, for example, the basic idea of the system is to monitor constantly pressure and temperature by means of TPMS sensors mounted on the tires and to use such data to detect out of range values of safety or sudden changes that may suggest the onset of problems on the tires.

In the event that a fire is detected, the system alerts the user and the remote desk operator so that it can proceed with the shutdown.

### LEGEND

1 apparatus for extinguishing fires installable on heavy goods industrial vehicles;
2 compact, modular and standardizable device for the formation of the extinguishing liquid;
3 pressurization box;
4 compartment bounded by the tank;
5 toroidal tank;
6 mixing chamber for the formation of the three-phase solution;
6a flat surface;
6b concave surface hosting the communication hole 30;
6c side hosting the communication hole 50 with the cassette 3;
6d, 6e opposing sides hosting holes 60 connecting with the hose reels 8;
7 pressurization means;
7a nitrogen gas or compressed air tank;
7b pressure reducer;
7c pressure calibration valves;
8 hose reel;
9 (9a, 9b) hose reel cases;
10 fixing brackets to the spars;
11 case;
11a upper casing;
11b lower casing;
12 temperature and/or pressure sensors;
13 activation means for the actuation of the valve for the opening/closing of the nitrogen/air tank,
14 signal indicator of the status of armed/unarmed device;
20 graphic interface of the control unit for signals detection;
30 communication hole with the nitrogen cylinder placed on the concave surface of the mixing chamber;
40 entry/exit hole on the tank 5;
50 communication hole placed on the side 6c of the mixing chamber 6;
60 holes placed on opposite sides 6d and 6e to connect with hose reels 8;
70 o-ring.

### BRIEF DESCRIPTION OF THE FIGS.

Other advantages, features and modes of use of the apparatus according to the present invention will become apparent from the following detailed description of some embodiments, given for example and being non-limitative and with particular reference to the attached figures, in which:

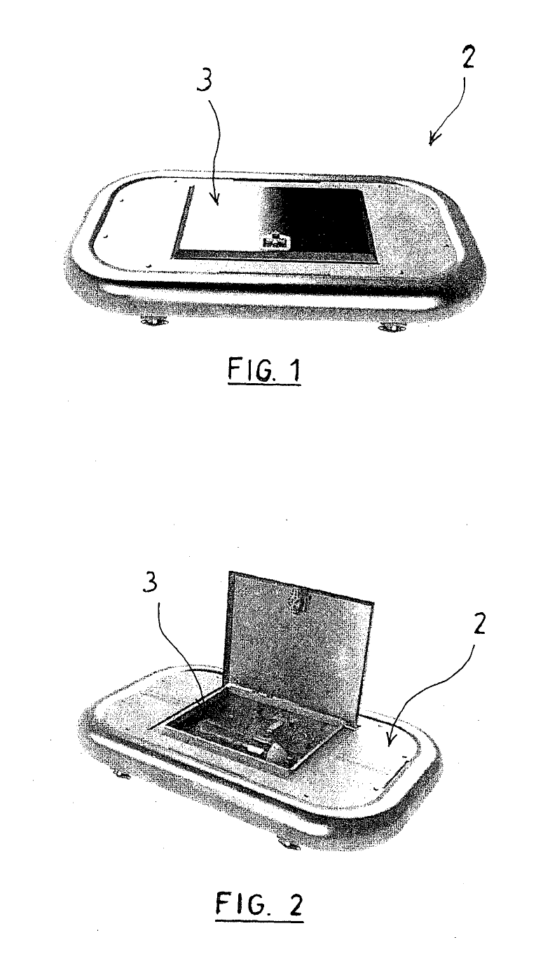

FIGS. 1, 2—perspective photographic views of the device 2 for the formation and pressurization of the liquid with the cover of the pressurization box 3 respectively in a closed position in FIG. 1 and in an open position in FIG. 2,

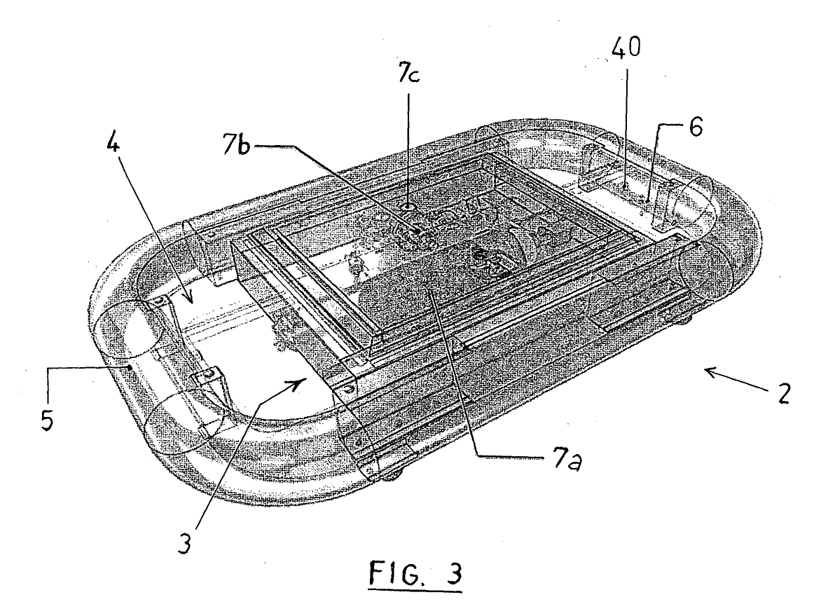

FIG. 3—a perspective view of the device of FIG. 1 with toroidal tank 5, mixing chamber 6 and pressurization box 3 depicted in transparency,

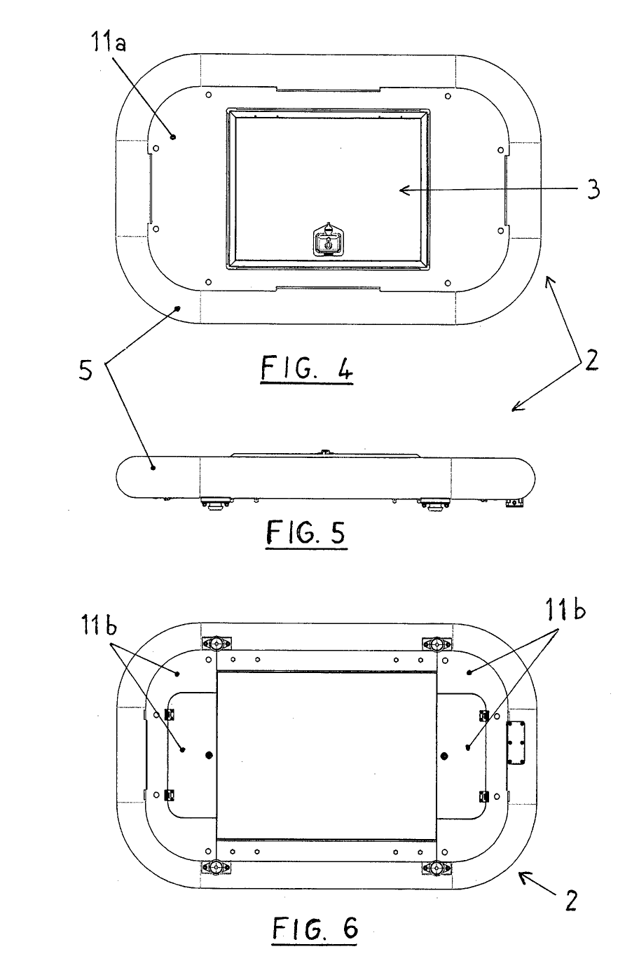

FIGS. 4, 5, 6—orthogonal views, respectively from the top, the front, and from the bottom of the device of preceding figures,

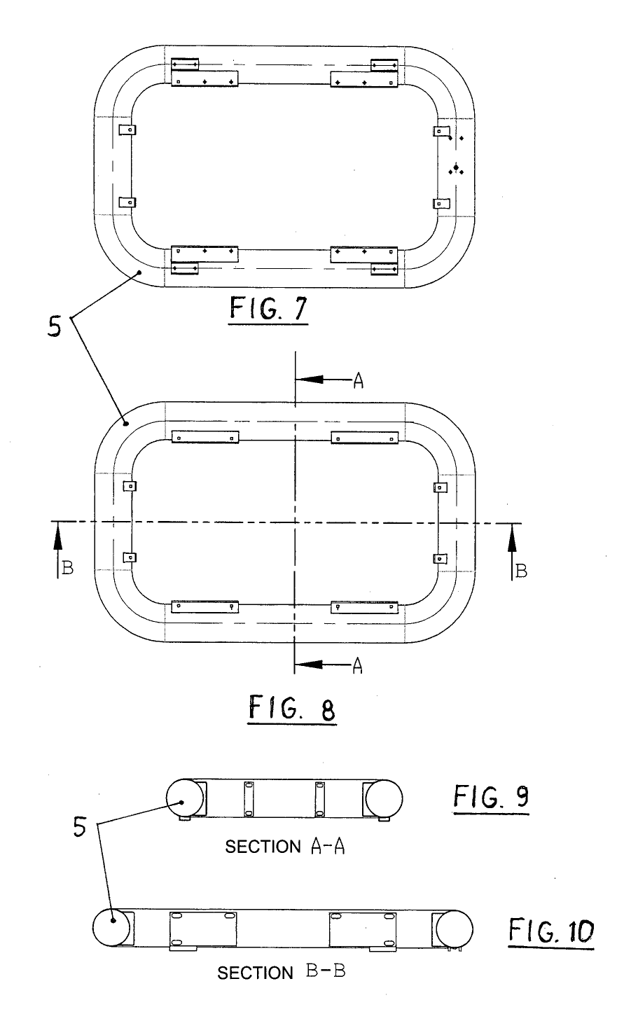

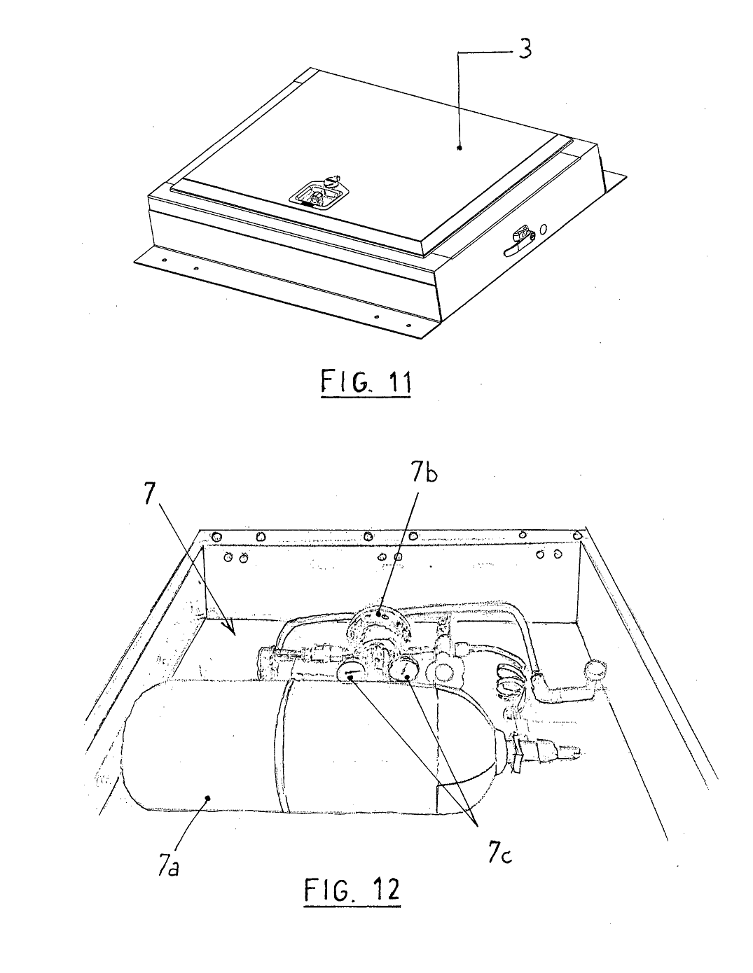

FIGS. 7, 8, 9, 10—orthogonal views respectively from the bottom, from the top, in section A-A, in section B-B of the toroidal tank 5 of the device,

FIG. 11—isometric view of the pressurization box,

FIG. 12—perspective view of pressurization means 7 contained in the pressurization box 3 of FIG. 11,

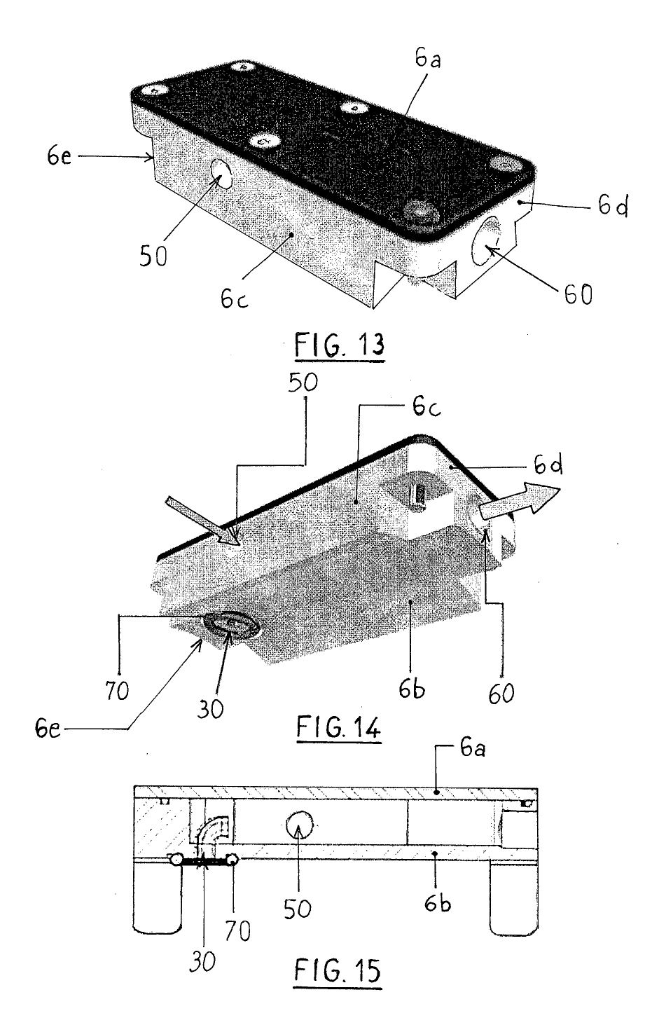

FIGS. 13, 14, 15—perspective views, respectively from the top, the bottom, and orthogonal section of the mixing chamber 6,

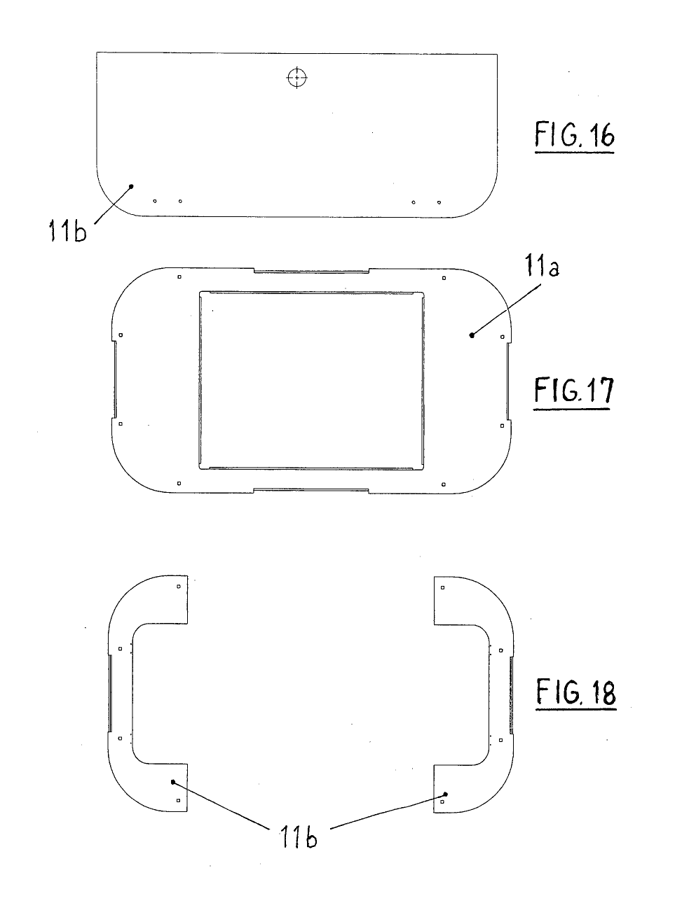

FIGS. 16, 17, 18—carters 11 and flap for fastening the device to the spars of the vehicle,

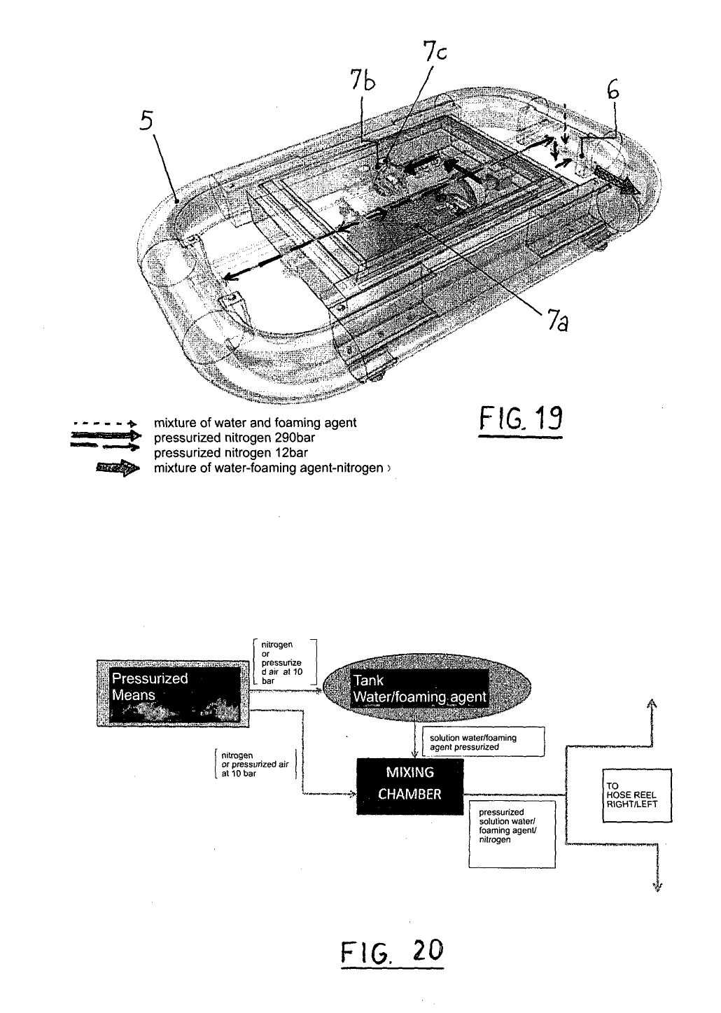

FIG. 19—a perspective view of the device of FIG. 3 with path of the liquids in the device,

FIG. 20—a schematic block diagram of the phases of operation of the device 1 after the its activation,

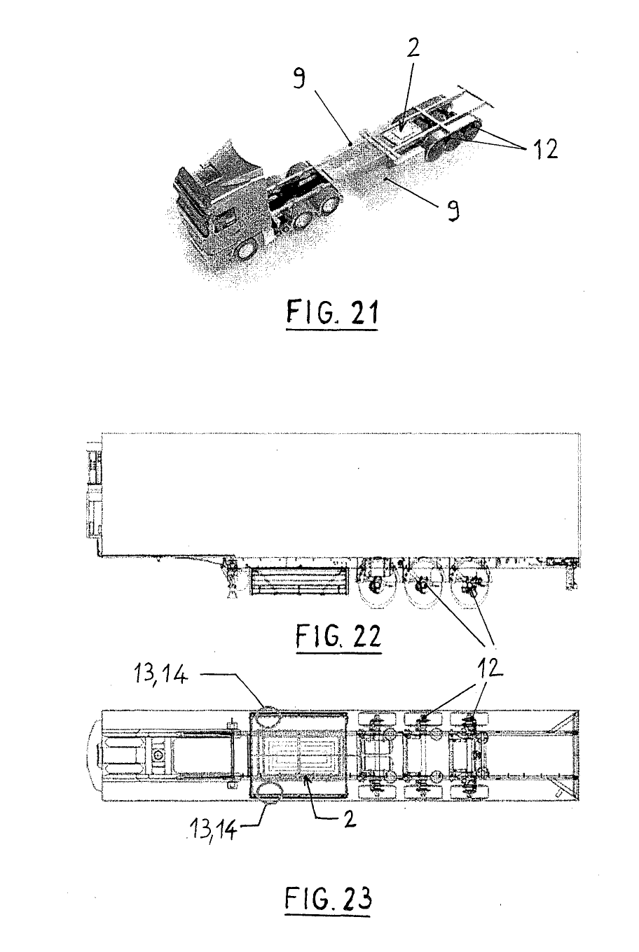

FIG. 21—a perspective view of a heavy goods vehicle provided with the device 2 and of the hose reel cases 9 according to the invention,

FIGS. 22, 23—orthogonal views, respectively lateral and from the bottom, of a trailer provided with the device 2,

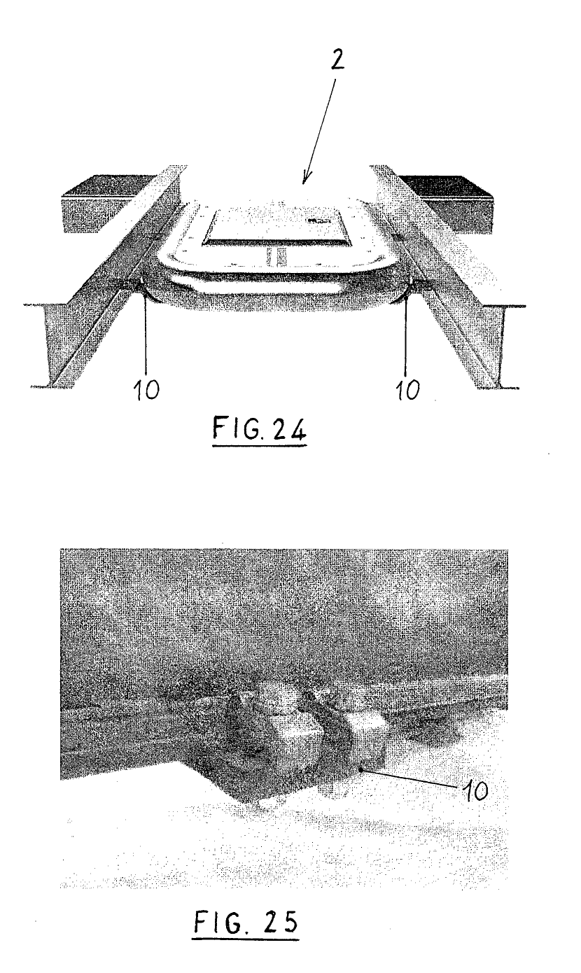

FIG. 24—perspective view of the device secured by means of junction devices 10 on the spars of a pallet of a heavy goods vehicle,

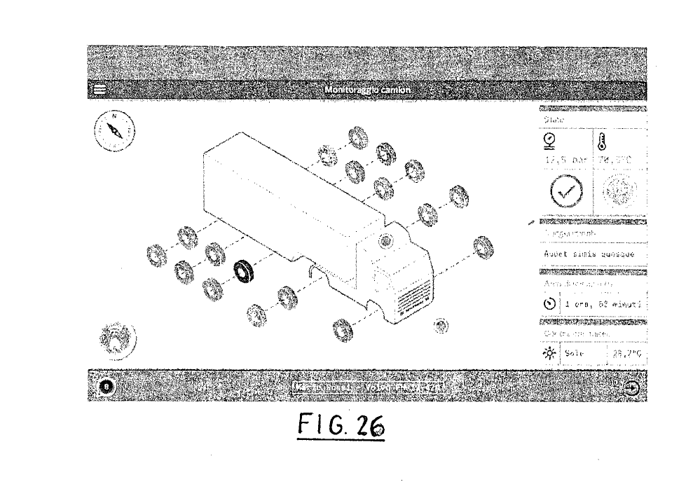

FIG. 25—a detail of the junction device to a spar of the pallet racking,

FIG. 26—a view of the software interface of the system for monitoring and prevent fire on a control unit of a heavy goods industrial vehicle provided on the tires of sensors for the detection of temperature and pressure.

### DESCRIPTION OF THE INVENTION

The apparatus for extinguishing fires 1 according to the invention, consists mainly by a device 2 for the formation and pressurization of an extinguishing liquid type CAF (Compressed Air Foam), illustrated in a preferred embodiment in figures from 1 to 19, mounted on a heavy goods vehicle, as shown in Figures from 21 to 25, having the purpose of rapidly extinguish, by means of human intervention or in some cases even in an automatic way, the outbreaks of fire that can develop on said vehicle.

Said apparatus 1 is used in case of fire to provide an expanded fireproof liquid in order to extinguish a fire or to protect unburned areas.

Typical components of the apparatus also comprise at least two reels 8 for the dispensing of said extinguishing liquid each placed in a case 9 provided with a device for the activation of said apparatus.

The device 2 for the formation of the extinguishing liquid is a compact, modular, standardizable device and is provided with a toroidal shaped tank illustrated in detail in FIGS. 7, 8, 9 containing a solution of water and foaming agent.

The toroidal tank 5 defines an almost rectangular compartment 4 in which is inserted a box 3 with a secure lock containing means 7 for pressurization of the solution of water and foam (see FIGS. 11 and 12) operatively interconnected; said pressurization means consist of:

a nitrogen gas (or compressed air) tank 7a,

a pressure reducer 7b,

pressure calibration valves 7c.

The toroidal tank 5 and the pressurization box 3 are provided with appropriate connection means.

Inside the compartment 4 delimited by the substantially toroidal shaped tank 5 is also inserted a mixing chamber 6 in which occurs the formation of a triphasic solution composed by water and foaming agent coming from the tank and nitrogen coming from the pressurization box.

Said mixing chamber 6 has a substantially parallelepiped shape with a flat surface 6a and an opposite concave surface 6b in a way that they can adhere to the convexity of the tank 5; on said surface 6b there is a communication hole 30 between the mixing chamber 6 and the tank 5, said communication hole 30 is placed in adherence to the hole 40 of the tank 5 via an O-ring.

On the surface 6c of said mixing chamber there is another hole 50, from which the nitrogen dispensed from the tank enters, connecting the mixing chamber 6 with the pressurization box 3; on the opposing surfaces 6d and 6e will be present holes 60 from which the water solution with the foaming agent and the compressed nitrogen (three-phase mixture) will exit; said holes 60 will be connected to the hose reels 8 in such a way that the three-phase solution goes out from the mixing chamber in the hose reels 8.

The shape of the mixing chamber 6 is such that is allocated in adherence to the toroidal tank 5 so that the entry hole 40 of the tank 5 adheres to the hole 30 of the mixing chamber 6 by means of an O-ring.

In a preferred embodiment, the apparatus 1 consists of the following two main devices, operationally connected:
an activation device enclosing a manual control device that enables and arms the pressurization circuit; in other words, it is an electro-mechanical control system which transmits the drive directly to the opening/closing valve of the tank containing compressed nitrogen pumping the pressured nitrogen inside the foaming agent tank and putting in pressure the extinguishing liquid. The activation device is contained within a hose reel case 9 provided with a button for the activation of the system;
an extinguishing or fire off device, which is the active part of the entire apparatus, comprising a pressurization group, contained in the box with the secure lock, consisting of a tank with nitrogen (or air) compressed of the capacity of 7.2 l and with a pressure of 290 bar, a pressure reducer (290 bar-12 bar) and calibration pressure valves, and the toroidal tank containing the water-foaming agent solution of the capacity of 90 l.

Complete the apparatus, the brackets 10 fixing the system to the spars of the semitrailer, hoses and junctions, fixing devices for the group and upper and bottom casing 11a, 11b that are detachable.

The extinguishing and fire off device is designed and manufactured according to the needs and characteristics of the heavy goods vehicle on which it will be installed or for the specific fire-fighting function that is intended to fulfill.

More in detail, the tank 5 is designed and customized in order to adapt itself to all the types of spars of the pallet racking of a heavy goods industrial vehicle; its toroidal shape and its characteristics were obtained through studies of fluid dynamics.

The device is also provided with a protective case 11 of the tank and of the pressurizing and mixing chambers.

The apparatus 1 is based on the following principle of operation illustrated schematically in FIG. 20.

In order to be able to use the device according to the invention the user after wearing the suitable protective devices must press the activation button in the hose reel case 9.

Therefore, it transmits the input from the release button to the opening electro-valve, positioned on the technical gas tank.

Once armed the apparatus, the technical gas (air or nitrogen) tank compressed to 290 bar contained in the pressurization box is used as a medium for putting in pressure to 12 bar, after reduction in a suitable pressure reducer, the mixing chamber 6 and the toroidal tank 5.

The tank is provided with a hole 40 adherent to the hole 30 of the mixing chamber; from this hole 40 the liquid has the opportunity to exit during the operation and to reach the mixing chamber 6 in which the mixtures water-foaming agent and the compressed nitrogen to 12 bar are conveyed, coming from the pressurization box (290 bar).

Inside the mixing chamber 6, the compressed nitrogen and the foaming agent will be mixed in suitable proportions, forming a water-foaming agent-nitrogen mixture.

The three-phase mixture of water-foaming agent-compressed nitrogen originated in this way (from 300 liters of water it can be produced approximately 800 liters of extinguishing substance), is then channeled through the reel 8 connected to the mixing chamber inside the fire-fighting reel.

The activation block of the extinguishing device placed inside each hose reel case 9 is equipped with a status indicator of the armed/unarmed device.

Once received the signal of armed apparatus from the activation device, the user pulls out the hose reel 8, together with the hydrant spear and using the lever for the delivery, integrated in the spear, which will activate the mechanism accelerating the motion of the liquid and bringing it to a rate which allows the mixture of water—foaming agent—nitrogen to flow along the outlet pipe reaching a thrown of the order of 15-20 meters.

The spears of the hose reels 8 may be provided with means for supplying air and for the expansion of the extinguishing liquid.

The splitting of the hose reel and the adoption of two hose reel cases 9a and 9b placed on the right and left sides of the vehicle allows to always have at least one hose reel 8 usable, in case one of the two sides is not easy to access.

This could be due to:
vehicle parked along a tunnel or close to a cliff or a wall;
vehicle accident due to a collision with other vehicles or with trees or other objects;
malfunction of one of the two channels, due to poor maintenance.

The fire class for which the device is intended is Class A.

The type of fire on which it is possible to act, among others, is that one caused by the combustion of one or two tires; such combustion may be the result of overheating of the tire as a result, for example, of a sudden and prolonged use of brakes.

In such cases, the apparatus 1 may be provided with temperature and/or pressure sensors 12, suitably placed for the detection and the transmission of data to a logic-operating unit, or to a control unit for the acquisition of signals, in wireless/bluetooth mode.

It should also be considered that the device is designed and developed to allow anyone to use it quickly and effectively.

However, to allow a use which is as effective as possible it is necessary to provide for the users an appropriate course of training and an update on the device and the fire-fighting techniques, as well as to inform the user about the risks involved and the main individual protection devices which have to be used such as gloves and respiratory protective masks.

The typical vehicle on which the device can be installed is a semi-trailer with three axis and two tires per axis.

Although there are several manufacturers of semitrailers of the identified type, the overall of the stands has generally a central pallet racking where it will be installed the fire protection system.

The device for the formation of the extinguishing liquid is installed on the central pallet racking fixing it to the spars by the use of simple mechanical junction devices, such as those employed for mounting the pallet rackings.

As regards the hose reel cases 9, the fixing method is the same as the extinguishing device, which is the use of mechanical joints for fixing on the pallet racking.

The apparatus according to the invention is simple and quick to install and, in addition, it provides the risk of fire and ensures an effective and rapid intervention in total safety for the operator, helping to improve the prevention on all heavy goods vehicles.

In its preferred embodiment the apparatus provides that the shutdown of any flames is carried out manually, with the intervention of the operator who, after having grasped the spear connected to the hose reel 8, directs the jet of the extinguishing liquid towards the fire.

In a further embodiment, the apparatus instead provides that the shutdown of any flames, for example on the tires, is carried out automatically.

Either through manual intervention of the operator both in the case of automatic shutdown it is also possible to provide a system for the monitoring and the prevention of fires on heavy goods industrial vehicles, in particular trucks equipped with the described apparatus. Said monitoring and fire prevention system includes a control unit for the acquisition of signals, connected to the temperature and pressure sensors 12 mounted on the vehicle-susceptible devices or axles, mudguards, chillers, etc., potential object of fire, both if the vehicle is running or when it stops.

Said temperature and pressure sensors transmit the measurements to a logical operation unit, or to a control unit for acquisition signals, in wireless mode and from said devices via bluetooth technology to a remote panel, or a tablet.

The acquired data managed through a hardware platform, software, firmware based on a client-server logic are then sent from the device to a remote server through 3G or 4G technology, which collects, stores and processes these data and sends it to the entire fleet of heavy goods industrial vehicles, particularly trucks, equipped with the above system, and allowing remote monitoring and activation of the alert messages.

In particular, said data acquired from the temperature and pressure sensors localized on susceptible areas, provides for example the value and the temperature characteristic of the tires in case of intensive use of the brakes in a portion of a road with high slope.

Said data would be further crossed with GPS positioning data as well as with the data of road maps in order to be stored and processed for advise by means of alert messages the presence of portion of road with high risk for overheating and burning of tires.

The system has the following key features:
monitoring the vehicle: made through sensors that allow the driver to constantly evaluate the presence of any anomalies monitored by a GPS which in turn allows to the control center to find the position of the vehicle in real time;
tele-assistance: by user-friendly interface, it allows the driver to access with a few gestures to the “service center” where he has an immediate display of the basic parameters and continuous assistance 24/24. In case of malfunction or critical event of the vehicle, the administrator is promptly informed by mail or notification; the remote maintenance of said system is also intended as a communication system by a remote server that processes all the data from the sensors and from the GPS of the vehicles and sends advice by means of alert messages relating to the fire of other road vehicles, or excessive overheating of the tires or advise about risky road portion where excessive heating of the tires may occur;
rapid response and fire extinguishing: the driver can carry out a manual intervention by the hose reel cassette, complete of tap and spears for the irrigation mounted under the cargo floor.

The two monitoring and remote maintenance phases, tightly integrated, ensure a constant monitoring of the main sources of ignition points on a heavy goods vehicle and adverse events.

The device and the system according to the invention allow a ready reduction of flue gas and of the temperature, permitting to limit any damage.

Using the most innovative monitoring technologies for the extinguishing of fires, the system and the device according to the invention have the purpose to develop a platform to be installed on heavy goods vehicles.

The present invention also intends to define and validate hardware architecture, modular software and firmware in which the security of the vehicle and devices installed on board is such as to ensure high safety and robustness of the application.

1. Fire-extinguishing apparatus installable on vehicles comprising:
an extinguishing liquid formation device; and
at least two hose reels for the delivering of said extinguishing liquid, each placed in a case comprising an activator for activating the extinguishing liquid formation device;
wherein the extinguishing liquid formation device comprises:
at least one substantially toroidal-shaped holding tank for holding a solution of water and foaming agent and defining a pressurization box compartment;
at least one pressurization box comprising a pressurizer comprising nitrogen gas and/or air; and
at least one mixing chamber for mixing water and foaming agent from the holding tank with nitrogen and/or air from the pressurization box;
wherein the pressurization box compartment is bounded by the holding tank and holds the at least one pressurization box and the at least one mixing chamber; and
wherein the pressurization box and the mixing chamber are interconnected, the mixing chamber and the holding tank are interconnected, and the mixing chamber and the at least two hose reels are interconnected.

2. Apparatus of claim 1 wherein the pressurizer comprises:
a tank containing the nitrogen gas and/or air;
a pressure reducer; and
pressure calibration valves.

3. Apparatus of claim 1 wherein the holding tank comprises an inlet/outlet connected to an inlet of the mixing chamber, through which, during the operation, solution of water and foaming agent from the holding tank is conveyed into the mixing chamber and mixed with a proportionate amount of nitrogen gas or air, coming from the pressurization box, forming within the mixing chamber a three-phase extinguishing fluid comprising water, foaming agent, and nitrogen or air.

4. Apparatus of claim 1 wherein said mixing chamber has a substantially parallelepiped shape with a flat surface and a concave surface, opposed to the flat surface, wherein said concave surface adheres to a convex surface of the tank with which it communicates through a communication hole on the concave surface, a side having a hole communicating with the pressurization box and two sides opposing each other which have connecting holes connected with the hose reels.

5. Apparatus of claim 4 wherein the communication hole on the concave surface of the mixing chamber is connected to an opening on the holding tank by an o-ring.

6. Apparatus according to claim 1 the extinguishing liquid formation device is provided with brackets for its fastening on spars of a truck and of an upper and lower casing.

7. Apparatus of claim 1 wherein the two hose reel cases are located on opposite sides of a heavy goods vehicle.

8. Apparatus of claim 2 wherein each reel case comprises:
an activator for direct activation of an opening/closing valve of the compressed nitrogen/air tank and inlet of pressurized nitrogen or air into the mixing chamber and
a status indicator of armed/unarmed device.

9. Apparatus of claim 1 comprising temperature and/or pressure sensors for detection and transmission of data to a logical operation unit in wireless/bluetooth mode.

10. Apparatus according to claim 9 comprising sensors for detection of temperature and/or pressure on tires of a heavy goods vehicle.

11. Method for the operation of the apparatus according to claim 1 comprising:
starting of the activator activation means,
opening of the valves of the nitrogen/air tank,
inlet of said nitrogen/air in the mixing chamber and in the holding tank,
conveying of water and foaming agent from the holding tank to the mixing chamber,
mixing of nitrogen/air with the water-foaming agent solution in the mixing chamber so as to form the three-phase extinguishing fluid water-foaming agent-nitrogen or compressed air,
flowing of the three-phase extinguishing fluid water-foaming agent-nitrogen or/compressed air from the mixing chamber to each hose reel,
turn on of status indicator of armed/unarmed device.

12. Method of claim 11 wherein the actuator is actuated by the pressure of an electromechanical control button present in each hose reel case.

13. System for monitoring and prevention of fire on heavy goods industrial vehicles provided with the apparatus according to claim 1 comprising a control unit of signals acquisition connected to temperature and pressure sensors mounted on susceptible elements of the vehicle which could be potential object of fire, wherein the system is adapted to be active whether the vehicle is moving or stationary.

14. System according to claim 13 wherein said temperature and pressure sensors transmit measurements to a logical operation unit, or to a signal acquisition unit, via wireless and then via bluetooth technology to a remote panel, such as to a tablet, said data being then sent from the tablet to a remote server, through 3G or 4G technology, which collects, stores and processes said data and sends to the fleet of heavy goods industrial vehicles provided with said system.

15. System according to claim claim 14 wherein data acquired by the sensors are managed by a hardware, software, firmware platform, based on a client-server logic and crossed with GPS positioning data and road map data, allowing remote monitoring, the activation of the alert messages and the signaling of road sections at risk of fire.
